(19) United States
(12) Patent Application Publication
(10) Pub. No.: US 2008/0290632 A1
(43) Pub. Date: Nov. 27, 2008

(54) Adjustable foot rest (for harness racehorse jogging cart)

(76) Inventors: Phillip Guadagni, Ferndale, MI (US); Arthur Anthony Vessella, Roseville, MI (US)

Correspondence Address: Phillip Guadagni, 3237 Kenwood, Ferndale, MI, 48220, US

(21) Appl. No.: 12/068,276

(22) Filed: May 22, 2008

Related U.S. Application Data
(60) Provisional application No. 60/899,464, filed on Feb. 6, 2007.

(51) Int. Cl. B62C 1/08

(52) U.S. Cl. 280/727

(57) ABSTRACT

The adjustable foot rest for racehorse jogging cart offers the driver alternative foot placement options compared to the traditional foot rest position. The alternative positions are designed to relieve neck/back stress and leg fatigue. The adjustable foot rest can be mounted in alternative positions to accommodate the needs of varying leg lengths. The adjustable foot rest can also provide an extra margin safety by securing the driver's feet in stirrups that are bolted to the steel frame. Finally, the adjustable foot rest is bolted on to the jogging cart making it an integral part of the cart rather than the usual “makeshift” methods.

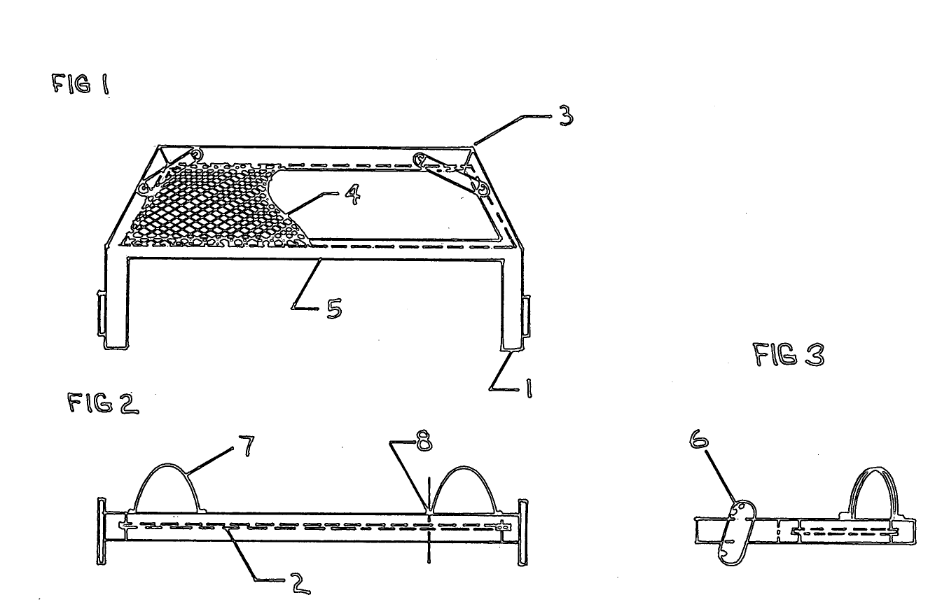

### PROBLEM

Harness racehorses are trained daily using jogging carts by drivers for up to 6-8 times around a ½ mild track per training period. In the final days before a race, horses will be trained twice per day. On a typical day, a driver might train up to a dozen different horses. Drivers are seated in the jogging cart with no back support and with their legs hyperextended and outstretched with their feet in stirrups 34″ apart—the distance between the shafts that connect the cart to the horse via hitches on the harness. Many drivers experience neck and lower back pain because of this ergonomically-incorrect position.

### DESCRIPTION, FUNCTION AND CONSTRUCTION OF EMBODIMENT

The device is bolted to a racehorse jogging cart by two endplates #6 which are welded at an angle to the frame #1. The location of the endplate holes allows the foot rest to be mounted in either of two positions i.e. closer vs. further from the driver's seat. The unit is framed using steel tubing that is slotted ⅛″ wide #2 to accept the expanded steel mesh #4 partial view, which is held in place with a crossmember #5. The mesh comfortably supports the driver's feet in a more natural sitting position. Two stirrups #7 are secured to the frame using ¼ “28×1½” bolts #8 for extra safety and a less stressed leg position—i.e. bent at the knee.

1. The adjustable foot rest for racehorse jogging cart offers the driver alternative foot placement options compared to the traditional foot rest position. The alternative positions are designed to relieve neck/back stress and leg fatigue.

2. The adjustable foot rest can be mounted in either of two positions to accommodate the needs of drivers with varying leg lengths. A shorter driver would have the foot rest mounted so that it is further from the ground and vice versa for the taller driver.

3. The adjustable foot rest can also provide an extra margin safety by securing the driver's feet in stirrups that are bolted to the steel frame.

4. Finally, the adjustable foot rest is bolted on to the jogging cart making it an Integral part of the cart rather than the usual “makeshift” methods.
